(19) United States
(12) Patent Application Publication
(10) Pub. No.: US 2010/0176605 A1
(43) Pub. Date: Jul. 15, 2010

(54) Derivative Electric Generator

(76) Inventor: Lawrence Wright, Coral Springs, FL (US)

Correspondence Address: Lawrence Wright, 5820 W Sample Rd, 201, Coral Springs, FL, 33067, US

(21) Appl. No.: 12/353,129

(22) Filed: Jan. 13, 2009

(51) Int. Cl. H02K 7/18; H02K 53/00

(52) U.S. Cl. 290/1 R; 415/916

(57) ABSTRACT

This invention is intended to produce enough electricity to power a household or supply a utility grid. The core system includes a DC or AC electric motor which has higher horsepower than required and lower wattage than its generator or alternator counterpart. Both share a power supply. The generator or alternator is regulated to a higher voltage than the shared power source. These core components are wired in either series or parallel.

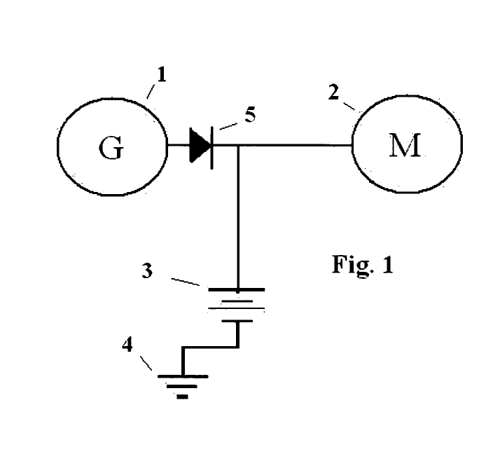

The system may run by direct drive assembly, or the motor and generator or alternator shafts may be connected by torque converter. Additional components enhance the generator's performance, reliability, and utility. The derivative generator is intended to serve consumers by producing the same energy with no air pollutants. This is technology that promotes a cleaner, safer, and more environmentally sound future. The invention will respond to the demands consumers, businesses, and utility companies.

### TECHNICAL FIELD

The invention is a method and an apparatus that converts mechanical torque to electricity, and is used in providing electricity to households or utility power grids. This may be used in place of other electrical power production methods like wind generators, gas and hydraulic turbines, nuclear energy, etc. Various techniques are used to convert mechanical torque to electricity for homes and utility grids. The present invention is ubiquitous and may be modified to suit any range of applications. This equipment is comparable to portable generators and turbines manufactured by the North American Industrial Classification System (NAICS) 335312 and the Standard Industry Classification Codes (SIC)3621, which comprise the electrical power equipment industry and refer to motor and generator manufacturing (2002, http://www.census.gov/epcd/naics02/def/NDEF335.HTM).

### BACKGROUND OF THE INVENTION

Consumer demand for generators is driven by reactions to events such as outages and natural disasters and prompted by security-related concerns. Homeowners are the largest segment of light duty portable generator purchasers and accounted for 57 percent of sales in 2002, according to a study by Frost and Sullivan. Increased reliance on power for home offices has also been linked to generator demand. Because natural disasters are typically tied to summer and fall tropical storms, those months result in the highest unit sales, according to Briggs and Stratton's annual report. In 2002, the U.S. Bureau of the Census reported that manufacturers shipped approximately $2 billion worth of gasoline and diesel driven generators carrying outputs ranging from 5-100 kW in the United States (2004, http://www.cpsc.gov/LIBRARY/FOIA/FOIA04/os/ecportgen.pdf).

Air pollutants generated by fossil fuels are of global concern and emissions from electric power plants have been cited as a major contributor. Portable and emergency generators pollute water and the exhaust is associated with lung cancer, bladder cancer, dizziness, drowsiness, headaches, and nausea in operators. Increased pressure at the state and national level has been building to control the emissions electricity production causes, and is paving the road for alternatives to fossil fuel technology. While nuclear energy is the viable solution for air pollution in large urban areas, radioactive byproducts are deadly and the cleanup is so costly. Nuclear energy also carries the potential risk of catastrophic meltdown (Fischer, 2005, p.7).

Greenhouse gasses and the threat of global warming have spawned the need for research and technology used to mitigate the impact of increases in global temperature. Global warming is caused by the emission of greenhouse gasses, and if nothing is done temperatures will continue to rise each year. Worldwide reports of protracted droughts, severe storms, and higher sea levels will increase incrementally with temperature changes. The shock to ecosystems will subvert evolution and accelerate the rate of extinction in some species, and studies report that action must be taken. This is an alternative to fossil fuel energy production, to reduce the damage caused by global warming (Conrad, 1997, p. 164).

### BRIEF SUMMARY OF THE INVENTION

The derivative generator is intended to serve consumers by producing the same energy with no air pollutants. This is technology that promotes a cleaner, safer, and more environmentally sound future. The invention will respond to the demands consumers, businesses, and utility companies. Outside of environmental gains, cost savings are another benefit. This is accomplished by eliminating fossil fuel consumption, while promoting clean air and other environmentally-friendly efficiency gains like noise reduction.

### BRIEF DESCRIPTION OF SEVERAL VIEWS OF THE DRAWING

This invention is intended to produce enough electricity to power a household or supply a utility grid. The core system includes a DC or AC electric motor which has higher horsepower than required and lower wattage than its generator or alternator counterpart, both sharing a power supply. The generator or alternator is regulated to a higher voltage than the shared power source, and these core components are wired in either series or parallel. The system may run by direct drive assembly, or the motor and generator or alternator shafts may be connected by torque converter.

Diagram 1 shows a system with predetermined voltage requirements

During operation, current output of the device can be measured in volt and ampere ratings with voltmeters. A motor controller or transistor will regulate the speed of electric motor. Devices for voltage drop measurements may be taken across the terminals and power capability curves would show outputs over a range of variable conditions. Tachometers for monitoring motor shaft speed and devices related to other critical measurements, like generator decrement curves showing thermal capacity limits, would also aid in optimizing efficiency. Circuit breakers, either thermal-magnetic or solid-state, or disconnect switches meet overcurrent protection standards and provide points of isolation. Applying a dual alternator could also target sources of power failure in components, or would provide asynchronous charge cycles for multiple battery banks.

### DETAILED DESCRIPTION OF THE INVENTION

The machine consists of a battery or utility grid-powered AC or DC electric motor turning a generator or alternator directly or by torque converter. The generator, in turn, powers the motor while feeding excess electricity to power other devices, recharge the battery, and/or supply additional wattage to the utility grid. The horsepower and kilowatt ranged of the motor and generator are predetermined to allow excess power supply for other devices, recharging the battery, and/or to supply power to a utility grid. Though the system if in no way limited to the specific components detailed in this description, this example uses an electric motor that requires 500V×300A=150,000W and produces 200 HP at 1,750 RPM. The second motor or alternator produces 500V×400A=200,000W at 268 HP and 1,750 RPM. The remaining current in the line would be 50,000W, enough power to power a household. Using an alternator rated too low for the maximum output will overload its diodes in the voltage regulator.

### REFERENCES

2004, http://www.cpsc.gov/LIBRARY/FOIA/FOIA04/os/ecportgen.pdf. Retrieved Dec. 9, 2007
2007, http://www.eia.doe.gov/emeu/recs/recs2001/enduse2001/enduse2001.html. Retrieved Dec. 9, 2007
Conrad, J. M. (1997, May) Global warming: when to bite the bullet. Land Economics, 73. 164-73. Retrieved from WilsonWeb Database
Fischer, P. A. (September 2005) Future nuclear? New, but not clear [Editorial]. World Oil, 226 (9) 7. Retrieved from WilsonWeb Database

1. Two or more electromagnetic motors electrically connected in parallel to a shared power source or sources.

2. An axial connection between the electromagnetic motors by either direct drive or torque conversion.

3. A diode present between the parallel connection of the generator-motor(s) and power source(s).

4-15. (canceled)
